(19) United States
(12) Patent Application Publication
(10) Pub. No.: US 2024/0418444 A1
(43) Pub. Date: Dec. 19, 2024

(54) A SYSTEM AND METHOD FOR DISCHARGING EVAPORATED PRODUCT MOISTURE FROM A DRUM DRYER

(71) Applicants: Solutherm B.V., Oss (NL); Tummers Beheer B.V., Hoogerheide (NL)

(72) Inventors: Pieter JELLEMA, Oss (NL); Jelle Luutzen NIJDAM, Oss (NL)

(21) Appl. No.: 18/700,183

(22) PCT Filed: Oct. 11, 2022
(86) PCT No.: PCT/NL2022/050580

§ 371 Date: Apr. 10, 2024

(30) Foreign Application Priority Data
Oct. 12, 2021 (NL) 2029388

(51) Int. Cl. F26B 21/12; F26B 3/20; F26B 17/28; F26B 25/00

(52) U.S. Cl. CPC F26B 21/12; F26B 3/20; F26B 17/284; F26B 25/008

(57) ABSTRACT

A system for the discharge of evaporated product moisture from a drum dryer, comprising:
a vapour hood for collecting evaporated product moisture from the drum dryer;
a discharge fan for discharging evaporated moisture from the vapour hood;
control means to control the fan, for example to adapt a volume flow rate of the discharge fan to a volume flow rate of evaporated moisture under the vapour hood; wherein the hood sealingly engages the drum of the drum dryer.

The invention also provides a method for the discharge of evaporated product moisture from a drum dryer, wherein the volume flow rate of the fan is such that an interface between vapour and air is located below a top of the drum of the drum dryer.

### FIELD OF THE INVENTION

The present invention relates to a system and method for discharging evaporated product moisture from a drum dryer, for example for the drying of a thin layer of a product to a dry sheet on an internally heated cylindrical drum of a drum dryer. In particular, an aspect of the invention relates to the discharge of evaporated moisture from a hood above or associated with a drum dryer in an essentially pure form, virtually without dilution of the vapour by air. Also, an aspect of the invention relates to a system and method for adapting a volume flow rate of moisture extracted from the hood above or associated with the drum dryer to a volume flow rate of the evaporated moisture from the product to the hood.

### BACKGROUND TO THE INVENTION

Drum dryers are applied for the drying of a thin layer of a pasty or pulpy wet material, such as a paper slurry, milk, proteins, tomato paste, bread dough or mashed potatoes. A drum dryer comprises a horizontal rotating cylinder, which is heated from the inside by steam. The initially wet product is evenly applied to a thin layer on the outer surface of the drum, for example by means of rotating cylindrical rolls, so-called applicator rolls. Additional applicator rolls along the circumference of the drum may be present to regulate the layer thickness, provide a kneading effect to the product, remove product imperfections and/or prevent lump formation. The product temperature increases after being applied to the drum by conductive heat transfer from the relatively warm (heated) contact surface of the drum, to which the product layer is in direct contact. From certain product temperatures on, the moisture inside the product starts to evaporate and the product gradually converts to a relatively dry sheet. The dried sheet is finally removed from the rotating drum, usually with the aid of a stagnant blade, the so-called doctor blade, after which the dry sheet is collected in/on and transported away by a discharge conveyor, e.g. a screw conveyer.

The evaporated product moisture is usually collected under a vapour hood placed above the drum and discharged to the atmosphere by means of a discharge fan. A volume flow rate of the discharge fan is usually substantially, typically a factor of about 10, larger than a volume flow rate of evaporated moisture from the product, for several reasons. Firstly, the hood is usually mounted at a certain distance above the drum. Entrainment of air from an environment process area to the vapour hood, along with the evaporated product moisture, is therefore inevitable, which hence requires excess flow rate of the discharge fan. Secondly, the more the evaporated product moisture is diluted by air from the process area, the lower the dewpoint of the discharged vapour-air mixture is. A low dewpoint is beneficial for avoiding condensation at the inside of the vapour hood, which is desirable from hygienic viewpoint avoiding droplets to fall on the product sheet underneath. The low dewpoint, however, has the disadvantage that the recovery of heat from the exhausted vapour-air mixture at a for re-use appropriate temperature level is no longer possible. Furthermore, the large volumes of discharged air from the process area have to be supplied from outside and conditioned again, which contributes substantially to the energy use of the HVAC equipment of the process area. Additionally, the exhaust of odorous components and steam cause nuisance to neighbours.

WO 2012/011805 discloses an apparatus for discharging vapour from a roller dryer, comprising a dome, to be placed over a vapour release area of a roller dryer, having a collecting space surrounded by a shell of the dome for collecting vapour rising from the roller dryer, and a condenser which is in flow connection with the dome for therein condensing vapour obtained from the collecting space. The flow rate of condensed steam can be regulated on the basis of a boundary layer present in the dome between vapour having collected in the dome and air located therebeneath. This regulation can take place, for instance, on the basis of the location or movement of the stratification layer with respect to the entry of the dome, and/or on the basis of measurement of temperature and/or density of gas present in the dome. The flow rate can also be regulated on the basis of a desired zero value of the entrance velocity of air into the dome. The transport of vapour from the dome to the condenser takes place by natural draught. The inlet of the condenser is for that reason located above the vapour outlet of the dome. A disadvantage of this known system is that vapour condensate from the condenser and from the duct between the outlet of the dome and inlet of the condenser can flow back to the dome and fall back on the to be dried product. Another disadvantage of this know system is that the size of the area of the boundary layer between the collected vapour in the dome and air therebeneath can be relatively large, namely as large as a length times a width of the dome, leading to undesired admission of air to the collected vapour under the dome.

CN213173136U discloses a dry-wet separation hot air penetration drying equipment, comprising a rack, a drying cylinder and a cover body, the cover body being divided into a dry part gas cover and a wet part gas cover, wherein a hot air grading circulating unit is arranged on the rack and comprises a wet part gas collecting cover and a dry part gas collecting cover. The covers are spaced-apart from a circumferential surface of the drying cylinder. Wet and dry product are fed and discharged via an upper side of the system.

US2002/004994 relates to a heating system for drying wet coatings such as printing inks, paint, sealants, etc. applied to a substrate. The drying system has a blower having an inlet directs a current of heated gas such as air towards a wet coating on a substrate to dry the coating and wherein the heated air is circulated back to the inlet of the blower once the air impinges the coating on the substrate.

CN108486946 discloses an integral hot steam drying cylinder and a system applying the same for waste heat utilization, in the technical field of papermaking, weaving, printing and nonwoven cloth drying. The integral hot steam drying cylinder specifically comprises a cylinder body, a tri-sleeve and a diversion plate.

### SUMMARY OF THE INVENTION

It is an object to provide a system for the discharge of vapour(s) from a drum dryer, and/or a method for the discharge of vapour(s) from a drum dryer, that obviates, or at least diminishes the disadvantages mentioned above. More in general, it is an object to provide an improved discharge system for undiluted vapours and/or method for discharging undiluted vapours from a drum dryer, in particular to enable a substantially complete condensation of the vapours at high temperature or reuse of these vapours as energy source, avoiding loss of energy and nuisance by emission to the atmosphere. Herein undiluted vapour can be defined as evaporated product moisture essentially without air from the process area.

Thereto, according to a first aspect is provided a discharge system that is defined by the features of claim 1.

According to an aspect there is provided a system for the discharge of evaporated product moisture from a drum dryer, comprising:
a vapour hood for collecting evaporated product moisture from the drum dryer;
a discharge fan for discharging evaporated moisture from the vapour hood;
control means to control the fan, preferably configured to adapt a volume flow rate of the discharge fan to a volume flow rate of evaporated moisture under the vapour hood;
wherein the hood sealingly engages the drum of the drum dryer.

It has been found that in this way, dilution of the evaporated moisture with environment air can be significantly reduced, so that complete condensation of the vapours at high, close to 100° C., temperature or reuse of these vapours as energy source is made possible, avoiding loss of energy and nuisance by emission to the atmosphere.

The sealing engagement can in particular provide at least one sealingly closed contact area between an outer circumference of the drum and the hood, for example three separate sealingly closed contact areas. Moreover, one of those sealingly closed contact areas can e.g. provide a sealing line that extends in parallel with respect to a rotation axis of the drum.

For example, the vapour hood can include a substantially closed ceiling extending above the drum, and for example at least four side walls, for example at least one substantially closed side wall extending between the drum and the ceiling.

According to an embodiment, at least part of the hood, in particular a substantially closed side wall (and preferably three of four closed side walls), sealingly engages a circumferential surface of the drum.

According to a preferred embodiment a single slit, providing a product passage, is defined between an inner surface of the hood and a circumferential surface of the drum.

The drum can be associated with a plurality of applicator rolls for pressing product onto a circumferential surface of the drum, wherein the hood can be configured to provide a sealing area with the circumferential outer surface of the drum before a first of the applicator rolls and after a last of the applicator rolls viewed along a drum direction or rotation.

According to an embodiment, the vapour hood can be brought sealingly into (mechanical) contact with an external surface of the drum, except for one lateral area which preferably contains a horizontal interfacial area where the collected vapour is in communication with the environmental air from the process area where the drum is placed into.

According to a preferred embodiment, the control means are configured to control the fan for the discharge of vapour from the hood such that an interface between vapour and air is located below a top of the drum of the drum dryer (i.e. below a horizontal plane that intersects a highest level of the drum's outer surface).

The skilled person will appreciate that the top of the drum is generally located at the vertical level (horizontal plane) that tangentially intersects the upper section of the outer surface of the drum. In other words: the top of the drum is the highest point of the drum's outer surface (during operation).

Similarly, according to a preferred embodiment, the control means are configured to control the fan for the discharge of vapour from the hood such that an interface between vapour and air is located above a horizontal plane that intersects a lowest level of the drum's outer surface. For example, the control means can include at least a first moist sensor for detecting moist in an area between the hood and the drum at a first vertical level below the top of the drum of the drum dryer, the first moist sensor (in particular being located at the respective first vertical level, the moist sensor for example being located in or near a side wall of the hood. It is preferred that the first vertical level (associated with the moist sensor) is located within a desired range of heights of a moist-air interfacial area. In other words: the moist sensor can preferably be located at vertical level that is within the desired range of heights of a moist-air interfacial area.

According to a preferred example, wherein the hood can include two or more moist sensors, for example temperature sensors, arranged at different elevations, preferably within a desired range of heights of a moist-air interfacial area. Optionally, each moist sensor can be placed inside an outer tube which has two open ends, one located at a measuring location and the other connected to a small suction fan, to increase the measuring accuracy or response time of the sensor.

Optionally, the vapour hood includes a condensate collection plate, arranged below a ceiling of the hood, wherein preferably a moisture inlet is provided between a distal edge of the condensate collection plate and an adjacent (opposite) inner side of the hood, to admit discharged vapour into a collection chamber defined between the condensate collection plate and the hood ceiling, wherein a downstream vapour discharge opening that is in fluid communication with said discharge fan is preferably at or near a proximal part of the condensate collection plate. For example, the condensate collection plate can be arranged at an inclination, or extends at an angle downwardly, towards a condensate discharge point.

The condensation collection plate (particular a top surface thereof) can collect condensate, e.g. to be discharged via a condensate discharge conduit, to avoid that such condensate reaches the drum (below) and product.

The system preferably includes a heat exchanger for receiving collected vapours, the heat exchanger preferably being configured to provide heat to a secondary circuit. For example, the heat exchanger can be configured to supply collected vapours to a secondary circuit by direct contact between the vapours and the secondary circuit, or alternatively by indirect contact between the vapours and the secondary circuit.

Furthermore, the system can be configured to pressurize collected vapours, to be fed to the drum dryer as heating medium of a inner side of a shell of the drum dryer. Alternatively or additionally, the inner side of the drum can also be heated in a different way, as will be appreciated by the skilled person.

The invention also provides a method for the discharge of evaporated product moisture from a drum dryer, the method for example utilizing a system according to the invention, wherein the method comprises:
collecting evaporated product moisture from the drum dryer by a vapour hood; and
discharging evaporated moisture from the vapour hood by a discharge fan;
wherein the fan is controlled such that a volume flow rate of the discharge fan is adapted to or associated with to a volume flow rate of evaporated moisture under the vapour hood;
wherein the volume flow rate of the fan is such that an interface between vapour and air is located below a top of the drum of the drum dryer (and for example at a vertical level above a lowest point of the drum's outer surface).

In this way, above-mentioned advantages can be achieved. In particular, the fan control is such that the vapour-air interface is at a relatively low (vertical) level, more particularly below the top of the drum (i.e. below a horizontal plane that intersects a highest point of a circumferential outer surface of the drum), so that the admittance of environmental air to the volumetric space under the vapour hood will (substantially) not occur.

The method can e.g. include a step of (e.g. temporary) decreasing the volume flow rate of the fan when a vertical level of the vapour-air interface is above a predetermined first level, the first level being at or below a top of the drum. The method can include a step of maintaining the volume flow rate of the fan substantially constant when a vertical level of the vapour-air interface is at a predetermined second level, the second level being below said first level and above a predetermined third level. Also, the volume flow rate of the fan can e.g. be (e.g. temporary) increased when a vertical level of the vapour-air interface is below the third level. The skilled person will appreciate that such fan control can be carried out in various ways, the fan control preferably being such that it is aiming at maintaining the vertical level of the vapour-air interface at a desired/predetermined level (e.g. being intermediate to said first level and third level). According to a preferred embodiment, the second level is lower than a surface area on the drum from where the to be collected vapours are evaporating from. The second level can e.g. be lower than the (vertical) level of a lowest applicator roll.

### Exemplary Embodiments of the Invention

A follows from the above, according to an embodiment, the discharge system can comprise a vapour hood configured for collecting the evaporated moisture from the product on the drum dryer. The vapour hood can hereby be brought sealingly into contact with the external surface of the drum, in particular except for one opening towards an environment process area outside the hood.

During normal operation, when product is dried on the drum, a contact area between air and vapour is preferably present inside this opening, which is denoted as interfacial area, a sharp horizontal boundary layer with air underneath and vapour above. This interfacial area is preferably located and maintained within a certain range of low elevations, but all preferably at least lower than the surface area on the drum from where the to be collected vapours are evaporating from.

A specific mass density of the vapours is typically a factor 1.5 to 2.5 lower than that of the environmental air outside the hood and underneath the interfacial area. This implies that all vapours formed on the evaporating surface area on the drum, will stay above the interfacial area and, for the same reason, all environmental air will stay below the interfacial area. For these physical reasons, neither vapour, nor environmental air is passing through the interfacial area. The admittance of environmental air to the volumetric space under the vapour hood will hence (substantially) not occur, neither via the open interfacial area, nor via one or more sealingly closed contact areas between the drum and vapour hood.

The vapour hood can further include measures to minimise condensation of vapour on the inner surfaces of the hood, for example by thermal insulation of the hood. Vapour condensation on the inner surface of the vapour hood can also be prevented by heating this inner surface to a temperature above the dew point of the vapours, for example by electrical tracing or steam tracing.

Also, the hood can be foreseen with a condensate collection plate, which can be mounted in a space above the drum and below a ceiling of the hood. Three of the four sides of the condensate collection plate can e.g. be connected to side walls of the vapour hood. At one side, a gap can be left open between an edge of the condensate collection plate and an adjacent sidewall of the hood. This gap can then be applied to uniformly discharge evaporated product moisture, preferably along the entire length of the evaporating surface area of the drum (viewed in axial drum direction), via the gap to the volumetric space above the condensate collection plate, e.g. to one or more vapour outlet connections for the discharge of vapours from the hood, preferably located at an opposite side with respect to the location of the gap. Said vapour discharge connections can e.g. be located near a ceiling of the hood and/or between the space above the condensate collection plate and the ceiling of the hood, and connect to a discharge duct, which for example connects to or includes the vapour discharge fan. An upper surface of the condensate collection plate can hence be exposed to the discharged vapour flow and can therefore be heated to the dew point temperature of this discharge flow. A bottom side of the condensate collection plate (facing the drum) can be exposed to the same vapour stream with the same dewpoint. Unwanted condensation of vapour on the bottom surface of the condensate collection plate, hence above an evaporating surface of the drum, will therefore preferably not occur.

Collected condensate, if any, can for example be discharged efficiently by mounting the condensate collection plate with an inclination towards one or more condensate discharge points, for example towards the vapour outlet connections.

An afore-mentioned open gap (moisture passage opening) at an edge of the condensate collection plate can optionally be foreseen with a filter, e.g. configured to separate product particles from the discharge vapours.

The discharge system can further comprise a discharge fan, of which a suction side is directly or indirectly, via an optional discharge duct, connected to the volumetric space above drum, or the volumetric space above the condensate collection plate if that is installed above the drum. The optional discharge duct permits that the discharge fan can be placed at any appropriate location with respect to the location of the discharge hood.

The discharge system can further comprise two or more sensors, for example temperature sensors, mounted e.g. into the vapour hood at at least two different elevations, but all preferably within a desired range of the vertical position with respect to the above mentioned interfacial area. In case of temperature sensors, these sensors can detect the presence of vapour by measuring a relatively high temperature or the presence of environmental air by measuring a lower temperature.

According to an example, a percentage/number of sensors that detect vapour provides information of the vertical position of the vapour-air interface. In case of temperature sensors, for example as follows:
elevation (i.e. vertical position) of said interfacial area is above all sensors, if all sensors measure a low (i.e. first) temperature;
elevation of interfacial area is between two neighbouring sensors, if the highest of the two measures a high (i.e. second) temperature (the second temperature being higher than the first temperature), and the lowest measures a low (i.e. the first) temperature;
elevation of interfacial area is below all sensors, if all sensors measure a high (i.e. the second) temperature.

Each sensor can optionally be placed inside an outer tube which has two open ends, one located at the measuring location and the other connected to a small suction fan, to increase the measuring accuracy or response time of the sensor. The sensor can also be configured differently, and can e.g. include an optical thermal sensor or different type of temperature sensor, as will be appreciated by the skilled person.

The discharge system can further comprise a control system (e.g. control unit or controller), which e.g. is configured to adjust the discharge flow rate of the discharge fan based on the signals received from the one or more (preferably two or more) sensors. A discharge flow rate can for example be increased in case of an increase of a percentage or number of sensors detecting vapour, or vice versa be decreased in case of a decrease of a percentage or number of sensors detecting vapour. The skilled person will appreciate that the control system can be connected to each of the sensors and the fan in various ways, one or more suitable communication lines, wired and/or wirelessly, a signal communication network, data-bus or the-like, for receiving sensor data or measurement results from the sensors and for controlling the fan using suitable fan control signals.

A vertical position of the vapour-air interface can according to a preferred control method be kept within a certain vertical range. Furthermore, for physical reasons explained above, (substantially) no air is admitted to the volumetric space under the vapour hood via the interfacial area. Therefore, and since the all other edges of the vapour hood are preferably brought into sealingly contact with the drum, (substantially) no environmental air is admitted to the volumetric space underneath the hood so that the vapour discharged from the hood consists only of evaporated product moisture, without any dilution of air from the environment.

Optionally, discharged undiluted vapours (i.e. moisture vapour discharged by the hood) can be pressurised by the discharge fan and supplied to a heat exchanger, where these undiluted vapours are preferably converted again to liquid at a condensation temperature near or close to the dewpoint of the undiluted vapours. Optionally, heat of condensation of the undiluted vapours can be transferred to a water circuit (e.g. a water circuit, including for example one or more water ducts, passing through the heat exchanger), via direct contact with the vapours or indirectly. As will be clear to the skilled person, such a water circuit can be separated from the vapours by heat exchanging surfaces of tubes and/or plates.

Optionally, the undiluted vapours (i.e. moisture vapour discharged by the hood) can be pressurised to a sufficiently high pressure value, that permits the use of the vapours as a heating medium for the inner surface of the drum dryer.

According to an aspect there is provided a discharge method for undiluted vapours from evaporated product moisture. The discharge method can comprise the collection of evaporated moisture from a product on a drum dryer underneath a vapour hood, which forms an enclosed space for collection of these vapours with the evaporating surface of the drum, preferably except for a single opening towards an environmental space outside the hood.

As follows from the above, the height (or vertical level) of the interfacial area between evaporated product moisture, above this area, and the environmental air from the process area, underneath, is preferably preserved at a height (vertical level) lower than that of the area on the drum from where the to be collected evaporated product moisture evaporates from. Preservation of this height can take place e.g. by measuring the presence of air or vapours at at least two different heights inside the opening and adapting a volume flowrate of a vapour discharge fan in a relation to the percentage or number of sensors that detect vapour.

The evaporated product moisture can be discharged from the volumetric space above the evaporation area, preferably via a relatively small/narrow (longitudinal) gap between a condensate collection plate and the adjacent sidewall of the vapour hood. Possible entrained product particles can optionally be separated from the discharged vapour by optional filters placed in and/or downstream of this gap. During operation, the discharged vapour subsequently preferably passes over a top side of a condensate collection plate and preferably heats this plate up to the temperature of the discharged vapours by convective heat transfer, hence avoiding the condensation of vapours at a bottom surface of this plate (which faces the drum and any product sheet on the drum). The vapours can be discharged from the hood e.g. via one or more vapour outlet connections, for example directly to a suction side of a discharge fan, or indirectly, via a discharge duct.

Optionally, the method further comprises the supply of the vapours to a heat exchanger, to convert the vapours again to liquid at a condensation temperature close to the dewpoint of the undiluted vapours.

Optionally, the method further comprises that the condensation heat of the vapours is transferred to a secondary water circuit passing through the heat exchanger, by direct contact with the vapours or indirectly, separating the secondary circuit from the vapours by the heat exchanging surfaces of tubes or plates.

Optionally, the method further comprises that the undiluted vapours can be pressurised to a sufficiently high level, that permits the use as heating medium for the inner surface of a drum dryer.

It will be appreciated that any of the aspects, features and options described in view of the discharge system apply equally to the method for discharging evaporated moisture (e.g. undiluted vapours), and vice versa. It will also be clear that any one or more of the above aspects, features and options can be combined in various ways.

### BRIEF DESCRIPTION OF THE DRAWINGS

Embodiments of the present invention will now be described in detail with reference to the accompanying drawings in which:

FIG. 1 shows a schematic representation of a drum dryer, in side view, with vapour hood and discharge fan according to the present state of the art;

FIG. 2 shows an opened side view of an example, in a schematic representation, of a non-limiting embodiment of the present invention;

FIG. 3A schematically shows a top view of part of the example shown in FIG. 2;

FIG. 3B schematically shows a bottom view of part of the example shown in FIG. 2;

FIG. 3C schematically a side view of part of the example shown in FIG. 2; and

FIG. 4 is similar to FIG. 2 and shows an embodiment configured to re-use discharge vapours as heating medium of the drum dryer.

### DETAILED DESCRIPTION

Similar or corresponding features are denoted by similar or corresponding reference signs in this application.

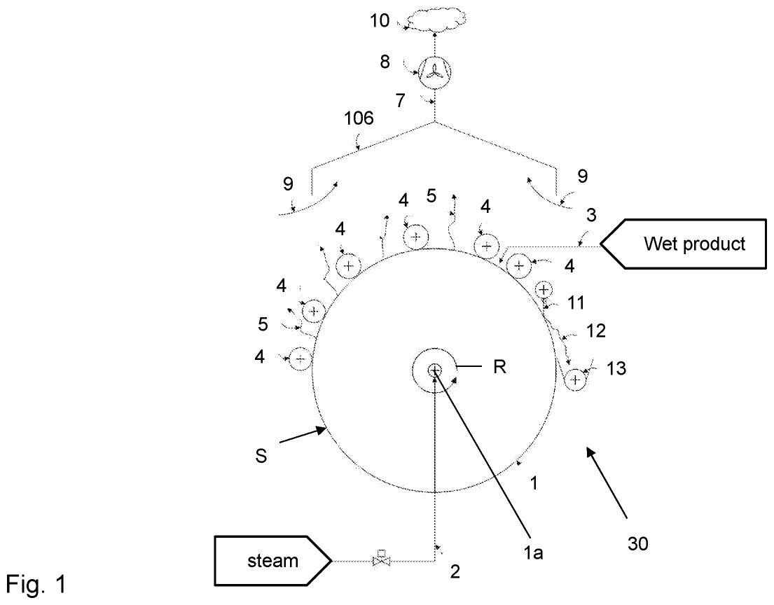

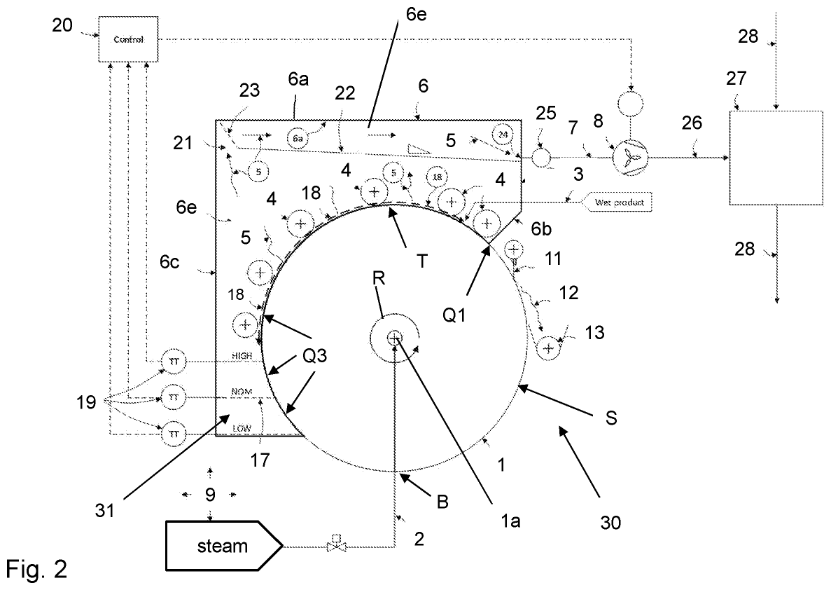

FIG. 1 shows an illustration of a drum dryer 30 with a vapour discharge hood above. The vapour discharge system of FIG. 1 has some disadvantages associated therewith which the present invention seeks to alleviate. The drum dryer 30 comprises a cylindrical drum 1. The system can include a drive or motor M (an example being schematically indicated in FIGS. 2B, 2C) for rotating the drum 1 around a respective axis 1a. During operation, a cylindrical shell of the drum is heated, e.g. from the inside by the supply of steam at a certain pressure, typically 5 to 12 barg.

The steam may for example be fed into the drum 1 via a respective central (e.g. hollow) axis 1a. Formed condensate inside the drum may e.g. be discharged via the same axis 1a, at the same side as the steam supply side, at the opposite side or at both sides.

The moisture containing, to be dried product 3 is applied to the external surface of the shell to a certain thickness, for example by means of one or more applicator rolls 4. After being applied to the drum, the product temperature increases by conductive heat transfer from the relatively warm contact surface of the drum. From certain temperatures on, the moisture inside the product starts to evaporate and leaves the product sheet in a vapour state 5. The remaining product material on the drum gradually converts to a relatively dry sheet. The sheet arrives at a certain point at a position where it is removed from the rotating drum with the aid of a stagnant blade, the so-called doctor blade 11. The dried sheet 12 is finally collected in and transported away by a screw conveyer 13.

The product drying on the drum dryer 1 is accompanied by a considerable vapour development 5. For example, when drying mashed potatoes, initially with 20% dry matter to dried flakes with 6% final moisture content, an amount of 3700 kg of vapour is released per 1000 kg of final product. If not diluted, this mass of vapour has a volume of approximately 6000 m³ and a dew point of 100° C.

The vapour is usually collected underneath a vapour hood 106 and is discharged from the production area to the atmosphere 10 via a discharge duct 7 and a discharge fan 8.

The flow rate of the discharge fan 8 is usually typically a factor 10 larger than the volume flow rate of the vapour stream from the product. In the example, per 1000 kg/h of dry flakes hence about 60.000 m³/h. The vapour stream 5 is hence volumetrically diluted with air 9 from the production area to a concentration of about 10 vol % before being discharged to the atmosphere 10. The dew point temperature of this diluted vapour-air mix is in the range of 40 to 50° C., which is well below the typical temperature range of 70 to 90° C. at which HVAC systems and other industrial heat demanding processes usually operate. Energy reclaim from the discharged vapour as heat source for processes is hence, after such degree of dilution with air, no longer possible. In addition, in the example 54000 m³/h of air 9 has been discharged from the production area, which has to be replaced again by fresh air from outside, which should be conditioned by a HVAC system before being supplied to the production area. This fresh air supply requires substantial amounts of energy for heating or cooling, especially when outside temperatures are substantially lower (winter) or higher (summer) than those in the production area.

FIGS. 2, 2A, 2B, 2C show an example of an improved system for the discharge of evaporated product moisture from a drum dryer 30. The system comprises a vapour hood 6 for collecting evaporated product moisture from the drum dryer 30. Also, the system includes a discharge fan 8 for discharging evaporated moisture from the vapour hood 6. A control means (control unit) 20 is present to control the fan 8, preferably to adapt a volume flow rate of the discharge fan 8 to a volume flow rate of evaporated moisture under the vapour hood 6. In the present example, wherein the hood 6 sealingly engages the drum 1 of the drum dryer 30.

For example, the vapour hood 6 can include a substantially closed ceiling 6a extending above the drum 1, and at least one substantially closed side wall 6b, 6c, 6d, 6e extending between the drum 1 and the ceiling, for example at least four side walls 6b, 6c, 6d, 6e. For example, the hood 6 and the opposite drum (for example a circumferential drum surface) can enclose/surround a processing space in a substantially air-tight manner with each other, except for a dried product discharge gap/opening 17.

For example, at least part 6d, 6e of the hood 6, in particular a substantially closed side wall (more particularly opposite side walls 6d, 6e), can sealingly engage a circumferential surface of the drum 1, and/or surrounds the drum 1 and/or a rotation axis 1a thereof. For example, sealing areas Q1, Q2, Q3 can be defined between wall edges (of respective hood parts/walls 6b, 6d, 6e) and the drum 1, a respective sealing engagement between the hood part 6b, 6d, 6e and drum 1 preferably being a substantially air-tight sealing. As follows from the drawings, the hood 6 can include side walls 6d, 6e that extend in parallel with respect to a the drum's axis of rotation 1a, and side walls 6b, 6c that extend normally with respect to the drum's axis 1a of rotation.

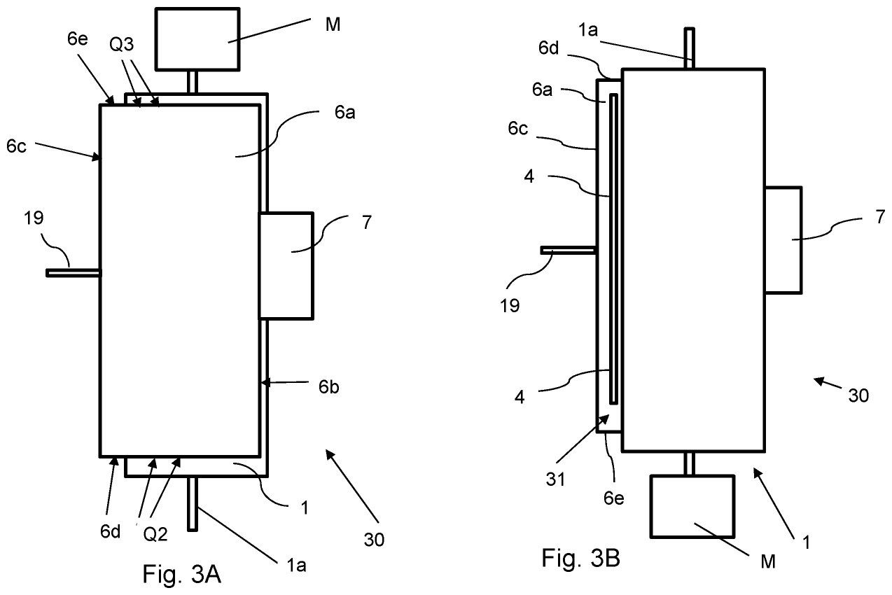

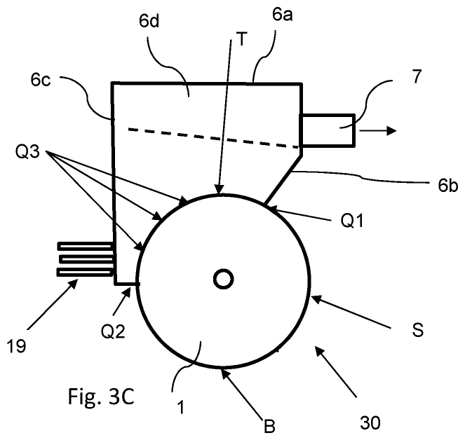

As follows from FIGS. 2 and 3B, a single slit or opening 31, providing a (dried) product passage or gap, can be defined between an inner surface of the hood 6 and a circumferential surface S of the drum 1.

As follows from the above, the drum 1 can be associated with a plurality of applicator rolls 4 for pressing product onto a circumferential surface S of the drum 1 (all rolls 4 preferably being located within an afore-mentioned substantially sealed processing space, and/or extending through sealed connections in respective opposite side walls 6d, 6e, e.g. via suitable bearings or seals). The hood 6 can be configured to provide at least a (first) sealing area Q1 with the circumferential outer surface S of the drum 1 before a first of the applicator rolls 4 and after a last of the applicator rolls 4 viewed along a drum direction or rotation R.

In particular, a side wall 6b of the hood that extends in parallel with respect to the drum's axis of rotation 1a sealingly engages the circumferential outer surface of the drum 1. More particularly, a horizontal edge of that side wall 6b engages the drum (thereby providing a respective seal Q1). The resulting seal Q1 can e.g. be a sealingly closed contact area (between the drum and the hood), i.e. a sealing line that extends in parallel with respect to the rotation axis 1a of the drum.

It follows that the vapour hood 6 can be brought sealingly into contact with an external surface S of the drum 1 (e.g. via respective sealing areas Q1, Q2, Q3), except for one lateral area 31. This lateral area 31 which preferably contains a horizontal moist-air interfacial area 17 (shown with dashed lines) which is in communication with the environmental air 9 from an process area (environment) where the drum 1 is located. As follows from the drawings, respective sealing edges of the hood 6 can mechanically contact the external surface S of the drum 1 without interruptions (i.e. there is no spacing between the sealing edges of the hood and the drum's external surface S) to provide respective sealing engagement. For example, the hood can define two spaced-apart arcuate sealing edges (provided by respective opposite hood side walls 6d, 6e, and matching an outer diameter of the drum) as well as a horizontal sealing edge (provided by a further side wall 6b) extending between the two arcuate sealing edges (wherein the sealing edges engage the drum's surface in an air-tight manner).

The system can include control means 20 (schematically indicated), that are preferably configured to control the fan 8 such that an interface 17 between vapour and air is located below a top of the drum 1 of the drum dryer. In the drawings, the top of the drum is indicated by arrow T. It follows that the top T of the drum 1 is the highest point of the outer surface of the drum, in other words, the top T of the drum 1 is located at a horizontal plane (i.e. a top vertical level) that intersects a highest point (or highest horizontal line) of the circumferential outer surface of the drum 1. Similarly, a lowest point of the drum 1 is indicated by arrow B, the lowest point in particular being a lowest point of the outer surface of the drum, at a lowest horizontal plane that (tangentially) intersects the circumferential outer surface of the drum 1.

The control means 20 can include (i.e. be provided with or connected to) at least a first moist sensor 19 for detecting moist in an area between the hood and the drum at a first vertical level below the top T of the drum 1 of the drum dryer 30, the first moist sensor 19 in particular being located at the respective first vertical level, the moist sensor 19 for example being located in or near a side wall of the hood. In a preferred embodiment, at least one or each moist sensor 19 is located below a vertical level of a lowest of said applicator rolls 4 (see FIG. 2). The hood preferably includes two or more moist sensors 19, for example temperature sensors, arranged at different elevations, preferably within a desired range of heights of a moist-air interfacial area 17. Each moist sensor 19 is can be configured in various ways. A sensor 19 can e.g. be placed inside an outer tube which has two open ends, one located at a measuring location and the other connected to a small suction fan, to increase the measuring accuracy or response time of the sensor.

As follows from the drawings, in particular, the first vertical level is located between the vertical level (i.e. horizontal plane) that intersects the top T of the drum 1 and the vertical level (i.e. horizontal plane) that intersects the lowest point B of the drum 1.

According to a preferred embodiment, the vapour hood 6 includes a condensate collection plate 22, arranged below a ceiling 6a of the hood 6. A moisture inlet 21 can be provided between a distal edge of the condensate collection plate and an opposite inner side of the hood 6, to admit discharged vapour into a collection chamber defined between the condensate collection plate and the hood ceiling 6. A downstream vapour discharge opening that is in fluid communication with said discharge fan 8 is preferably at or near a proximal part of the condensate collection plate 22. For example, the condensate collection plate 22 can be arranged at an inclination, or extends at an angle downwardly, towards a condensate discharge point. A moist discharge opening of the hood preferably includes a filter 23 (as will be explained below).

During use, the system can carry out a method for the discharge of evaporated product moisture from the drum dryer 30. The method can include collecting evaporated product moisture from the drum dryer 30 by a vapour hood 6, and discharging evaporated moisture from the vapour hood 6 by a discharge fan 8. Preferably, the fan 8 is controlled such that a volume flow rate of the discharge fan 8 is adapted to or associated with a volume flow rate of evaporated moisture under the vapour hood 6. For example (as is mentioned before), the volume flow rate of the fan 8 can be such that the interface 17 between vapour and air is located below a top T of the drum 1 of the drum dryer. The volume flow rate of the fan 8 can be decreased (for example temporally) when a vertical level of the vapour-air interface 17 is above a predetermined first level, the first level being at or below a top T of the drum 1. The volume flow rate of the fan 8 is preferably held constant when a vertical level of the vapour-air interface 17 is at a predetermined second level, the second level being below said first level and above a predetermined third level. Also, the volume flow rate of the fan 8 is preferably increased (for example temporally) when a vertical level of the vapour-air interface 17 is below the predetermined third level. As follows from the drawings, the second vertical level and the third vertical level can be above the vertical level that intersects the the lowest point B of the drum 1.

Referring to FIG. 2, in particular, there is shown an example of a system and method for discharging undiluted vapours from a drum dryer 30. In this example, a vapour hood 6 can be placed over the drum 1. Two opposite sides (side walls) 6d, 6e of the hood are preferably foreseen with a cutout which matches exactly with a round shape of the drum 1, providing a closed connection between these sides 6d, 6e and a cylindrical outer surface S of the drum (see FIG. 3C), in particular providing respective (second) sealing areas Q2, Q3 along the outer surface S of the drum. In other words, said opposite sides (side walls) 6d, 6e of the hood can have curved edges, matching and sealingly engaging an opposite surface S of the rotating drum 1. According to an example, said applicator rolls 4 extend between the two spaced-apart side walls 6d, 6e of the hood (and preferably sealingly extend through those side walls 6d, 6e). The two spaced apart side walls 6d, 6e can e.g. extend in parallel with each other, and e.g. normally with respect to an axis 1a of rotation of the drum 1. Also, according to an embodiment, the two spaced apart side walls 6d, 6e can be configured to rotatingly hold or support the drum (e.g. its axis 1a) and respective applicator rolls 4, e.g. via respective bearings, seals or suitable couplings (not shown) as will be appreciated by the skilled person.

A third side (side wall) 6b, e.g. between or near a doctor blade 11 and the application location of wet product 3, is preferably also in closed connection with the at this point empty drum surface S (providing an afore-mentioned sealing area Q1 as well). As a result, there remains only one area 17, between third 6c and fourth sides 6d, 6e of the hood 6 and the adjacent/opposite surface S of the drum 1, the area being is in communication with environmental air 9 from the process area.

During operation, a vertical position of a said horizontal interfacial area 17 preferably ranges between the levels indicated as LOW and HIGH, whereby the level HIGH is preferably always located below the lowest height of a surface area 18 (dashed line in FIG. 2) from where the to be collected evaporated product moisture is evaporating from at the drum surface. Said surface area 18 in particular extends between a first and last applicator roll 4 viewed along the circumferential surface S along a drum rotation direction R.

The vertical location of this interfacial area can e.g. measured by means of at least two sensors 19, which are connected to a control unit 20. The sensors 19 detect the presence of vapour 5 or air. As will be appreciated by the skilled person, if these sensor 19 are temperature sensors, then the presence of vapour can be detected by measuring a relatively high temperature, of at least 90° C. The presence of environmental can be measured by measuring a lower temperature, of for example 50° C. or lower.

According to an embodiment, the ratio of the number of sensors that detect vapour versus the number that detects air can provide information of the vertical position of the interfacial area. Based on this information, the interfacial area can be maintained within a certain range of levels HIGH-LOW by means of the control unit 20 which preferably adapts the flow rate of the discharge fan 8 to the volume flow rate of evaporated vapour 5.

During operation of the drying process, a continuous volume flow of vapour 5 can be supplied to the volumetric (substantially sealed) space under the hood 6, the vapour 5 originating from the evaporation process of product moisture from surface 18. The formed vapour is preferably discharged from the volumetric space via a (preferably small) longitudinal gap 21 between a condensate collection plate 22 and the adjacent side/section 6c of the vapour hood 6. Possible product particles can optionally be separated from the discharged vapour by one or more optional filters 23 placed inside or downstream of the gap.

The discharged vapour subsequently passes over the top side of the condensate collection plate 22 and can be discharged from the hood via one or more outlet connections 24 of the vapour hood, directly to the suction side of a discharge fan 8, or indirectly, e.g. via a discharge manifold 25 and duct 7.

If condensate droplets fall from the inner surface of the ceiling 6a of the vapour hood, then these droplets are collected by the condensate collection plate 22, avoiding that such droplets fall on the product sheet on the drum 1. Condensate formation on an inner surface of an upstream wall 6c of the hood 6 e.g. can be discharged towards the process area and can be collected there. Condensate formation on an the inner surface of a downstream hood wall 6b can e.g. be discharged towards the at that location empty drum surface, to be re-evaporated there. Any possible contact between condensate and product is hence reduced or prevented.

Summarizing, the innovative discharge system can comprise a vapour hood 6 configured for collecting the evaporated moisture from the product on the drum dryer 30. The vapour hood 6 is hereby preferably brought sealingly into contact with the external surface S of the drum 1, except for one (horizontal) interfacial area which is in communication with environmental air 9 from the process area where the drum is placed into. During normal operation, when product is dried on the drum, this interfacial area is preferably located within a certain range of low elevations, but preferably all at least lower than the surface area on the drum from where the to be collected vapour is evaporating from. In this way, the admittance of environmental air to the volumetric space under the vapour hood will (substantially) not occur.

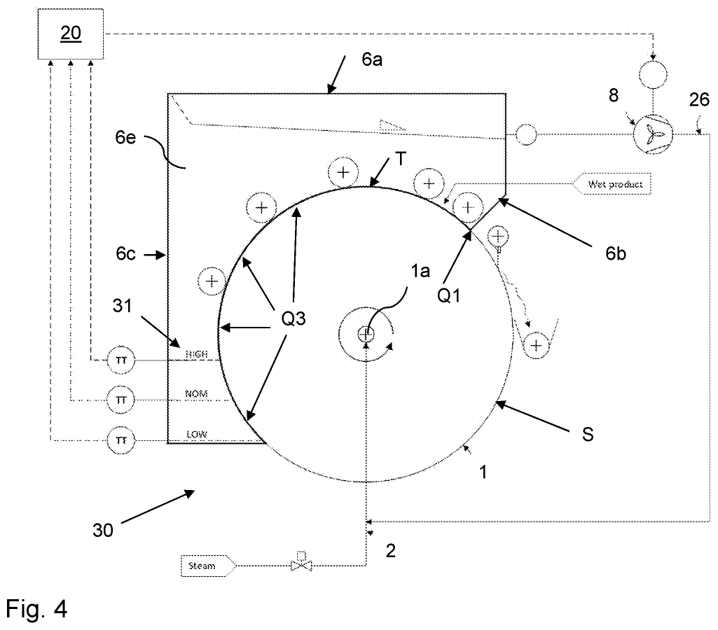

FIG. 4 shows an example that includes a heat exchanger 27 for receiving collected vapours.

The heat exchanger 27 can e.g. be configured to provide heat to a secondary circuit 28. Also, the heat exchanger 27 can be configured to supply collected vapours to a secondary circuit 28 by direct contact between the vapours and the secondary circuit 28. Alternatively, for example, the heat exchanger 27 can be configured to supply collected vapours to a secondary circuit 28 by indirect contact between the vapours and the secondary circuit 28. Further, the system can be configured to pressurize collected vapours, to be fed to the drum dryer 30 as heating medium of a inner side of a shell of the drum dryer 30.

FIG. 4 shows a possible configuration where the discharged vapours can be pressurised by discharge fan 8 and added to a steam supply 2 of the drum 1. The discharge fan 8 can operate in this example as what is generally known as a mechanical vapour compressor, pressurising the steam to the same range of pressures (5 to 12 bar) as those of the live steam, in order to reduce the live steam consumption of the drum dryer.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

However, other modifications, variations, and alternatives are also possible. The specifications, drawings and examples are, accordingly, to be regarded in an illustrative sense rather than in a restrictive sense.

For the purpose of clarity and a concise description features are described herein as part of the same or separate embodiments, however, it will be appreciated that the scope of the invention may include embodiments having combinations of all or some of the features described.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

The control means can be configured in various ways, as will be appreciated by the skilled person. For example, the control means can include control equipment or a control unit or a control system, e.g. connected to the one or more moist/temperature sensors 19, for controlling a discharge flow rate of the discharge fan. The control means can include e.g. hardware and/or software, a processor, a computer, computer program, computer program product and/or the-like, configured for carrying out respective control means operation/functioning, as will be clear to the skilled person.

The fan can be configured in various ways and can include one or more discharge pumps or pumping means, for example an air pump, or the-like.

Heating means for heating the drum 1, in particular a circumferential surface S thereof, can be configured in various ways, for example via integrated electrically powered heating elements, and/or by heating means configured for supplying a heating medium (e.g. steam) to the drum, or differently.

1. A system for discharge of evaporated product moisture from a drum dryer, comprising:
a vapour hood for collecting evaporated product moisture from the drum dryer;
a discharge fan for discharging evaporated moisture from the vapour hood;
control means to control the discharge fan, for example to adapt a volume flow rate of the discharge fan to a volume flow rate of evaporated moisture under the vapour hood;
wherein the vapour hood sealingly engages a drum of the drum dryer, the sealing engagement providing at least one sealingly closed contact area between an outer circumference of the drum and the hood.

2. The system according to claim 1, wherein the vapour hood includes a substantially closed ceiling extending above the drum, and at least one substantially closed side wall extending between the drum and the ceiling.

3. The system according to claim 1, wherein at least part of the vapour hood sealingly engages a circumferential surface of the drum and/or surrounds the drum and/or a rotation axis thereof.

4. The system according to claim 1, wherein a single slit, providing a product passage, is defined between an inner surface of the vapour hood and a circumferential surface of the drum.

5. The system according to claim 1, wherein the drum is associated with a plurality of applicator rolls for pressing product onto a circumferential outer surface of the drum, wherein the vapour hood is configured to provide a sealing area with the circumferential outer surface of the drum before a first of the applicator rolls and after a last of the applicator rolls viewed along a drum direction of rotation.

6. The system according to claim 1, wherein the vapour hood is brought sealingly into contact with an external surface of the drum, except for one lateral area which contains a horizontal moist-air interfacial area which is in communication with environmental air from a process area where the drum is placed into.

7. The system according to claim 1, wherein the control means are configured to control the discharge fan such that an interface between vapour and air is located below a top of the drum of the drum dryer and/or below a horizontal plane that intersects a highest point of a circumferential outer surface of the drum.

8. The system according to claim 1, wherein the control means include at least a first moist sensor for detecting moisture in an area between the vapour hood and the drum at a first vertical level below a top of the drum of the drum dryer, the first moist sensor being located at the respective first vertical level, the moist sensor being located in or near a side wall of the vapour hood, wherein the first vertical level is located within a range of heights of a moist-air interfacial area, wherein the first vertical level is above a horizontal plane that intersects a lowest point of a circumferential outer surface of the drum.

9. The system according to claim 1, wherein the vapour hood includes two or more moist sensors or temperature sensors, arranged at different elevations, within a range of heights of a moist-air interfacial area.

10. The system according to claim 9, wherein each moist sensor is placed inside an outer tube which has two open ends, one located at a measuring location and the other connected to a small suction fan, to increase measuring accuracy or response time of the sensor.

11. The A system according to claim 1, wherein the vapour hood includes a condensate collection plate, arranged below a ceiling of the vapour hood, wherein a moisture inlet is provided between a distal edge of the condensate collection plate and an opposite inner side of the vapour hood, to admit discharged vapour into a collection chamber defined between the condensate collection plate and the ceiling, wherein a downstream vapour discharge opening that is in fluid communication with said discharge fan is at or near a proximal part of the condensate collection plate.

12. The system according to claim 11, wherein the condensate collection plate is arranged at an inclination, or extends at an angle downwardly, towards a condensate discharge point.

13. The system according claim 1, wherein a moist discharge opening of the vapour hood includes a filter.

14. The system according to claim 1, including a heat exchanger for receiving collected vapours, the heat exchanger being configured to provide heat to a secondary circuit.

15. The system according to claim 14, wherein the heat exchanger is configured to supply collected vapours to the secondary circuit by direct contact between the vapours and the secondary circuit.

16. The system according to claim 14, wherein the heat exchanger is configured to supply collected vapours to the secondary circuit by indirect contact between the vapours and the secondary circuit.

17. The system according to claim 1, wherein the system is configured to pressurize collected vapours, to be fed to the drum dryer as heating medium of an inner side of a shell of the drum dryer.

18. A system for the discharge of evaporated product moisture from a drum dryer comprising:
a vapour hood for collecting evaporated product moisture from the drum dryer;
a discharge fan for discharging evaporated moisture from the vapour hood;
control means to control the discharge fan to adapt a volume-flow rate of the discharge fan to a volume flow rate of evaporated moisture under the vapour hood;
wherein the control means are configured to control the discharge fan such that an interface between vapour and air is located below a top vertical level that that intersects a highest point of a circumferential outer surface of the drum dryer,
wherein the control means include at least a first moist sensor for detecting moist in an area between the vapour hood and the drum dryer at a first vertical level below the top vertical level, wherein the first vertical level and/or the at least first moist sensor is located within a range of heights of a moist-air interfacial area;
wherein the vapour hood sealingly engages a drum of the drum dryer.

19. The A system according to claim 18, wherein the vapour hood includes:
a substantially closed ceiling extending above the drum;
at least four substantially closed side walls extending between the drum and the ceiling, wherein the at least four substantially closed side walls include two opposite side walls that extend normally with respect to an axis of rotation of the drum and two side walls that extend in parallel with respect to the axis of rotation of the drum,
wherein one of the four substantially closed side walls of the vapour hood that extends in parallel with respect to the drum's axis of rotation sealingly engages a circumferential outer surface of the drum, wherein a horizontal edge of the latter side wall engages the drum.

20. The A system according to claim 18, wherein the vapour hood defines two spaced-apart arcuate sealing as well as a horizontal sealing edge extending between the two arcuate sealing edges, wherein each sealing edge engages the drum's outer surface in an air-tight manner.

21. A method utilizing the system according to claim 1 for the discharge of evaporated product moisture from the drum dryer, the method comprising:
collecting evaporated product moisture from the drum dryer by the vapour hood; and
discharging evaporated moisture from the vapour hood by the discharge fan;
wherein the discharge fan is controlled such that a volume flow rate of the discharge fan is adapted to or associated with a volume flow rate of evaporated moisture under the vapour hood;
wherein the volume flow rate of the discharge fan is such that an interface between vapour and air is located below a top of the drum of the drum dryer and/or below a horizontal plane that intersects a highest point of a circumferential outer surface of the drum.

22. The method according to claim 21, wherein the volume flow rate of the discharge fan is decreased when a vertical level of the vapour-air interface is above a predetermined first level, the first level being at or below the top of the drum, the first level being above a lowest point of the drum.

23. The method according to claim 22, wherein the volume flow rate of the discharge fan is held constant when the vertical level of the vapour-air interface is at a predetermined second level, the second level being below said first level and above a predetermined third level.

24. The method according to claim 23, wherein the volume flow rate of the discharge fan is increased when the vertical level of the vapour-air interface is below a predetermined third level.

25. The method according to claim 21, wherein the vapour hood includes at least one side walls that contacts the circumferential outer surface of the drum in an air-tight manner.
